(19) United States
(12) Patent Application Publication
(10) Pub. No.: US 2011/0085862 A1
(43) Pub. Date: Apr. 14, 2011

(54) End mill grooved chip breaker flute

(76) Inventor: William Allen Shaffer, Scottdale, PA (US)

(21) Appl. No.: 12/587,649

(22) Filed: Oct. 10, 2009

(51) Int. Cl. B23C 5/10; B23C 9/00

(52) U.S. Cl. 407/54; 407/116

(57) ABSTRACT

A new chip breaking end mill is disclosed having an elongate cylindrically shaped body with opposing shank and cutter ends wherein at least one flute is spirally formed around the center axis of the cylindrically shaped body and the flute extends axially from the shank end to the cutting end. A cutting edge is formed by the intersection of the flute with the outer diameter of the cylindrically shaped body and extends longitudinally of the cylindrically shaped body. A concave, facing outwardly, chip breaker groove is formed in the flute and located adjacent to the cutting edge and the groove extends axially along with the cutting edge on the cylindrically shaped body. A chip guide channel is located adjacent to, and on the other side of the chip breaker groove than the cutting edge and it also extends axially along the length of the body. A longitudinally extending raised intersection is formed between the adjacent chip breaker and chip guide. Two radial lines, one drawn from the centerline of said cylindrically shaped body through the cutting edge and the other drawn from the centerline through a point on the raised intersection, have an acute included angle of from 2 to 20 degrees. The cutting end of the end mill has a radially extending cutting edge thereon which is substantially perpendicular to the central axis of the cylindrically shaped body.

### BACKGROUND OF THE INVENTION

This invention has to do with end mills and is especially concerned with providing end mills with an effective way to efficiently and expeditiously remove material from a workpiece. End mills provide cutting action in two important ways. First there is a plunging action where the axial end of the cylindrical body moves a predetermined depth into the surface of a work material. Once the end mill is at the predetermined depth, it is then moved horizontally along the surface of the work material so as to cut sideways from the initial cut into the work material. A usual method of end milling requires a first rapid and rough cut, followed by a finish cut, to provide the required finish on the final work material. The purpose of the rapid first cut, or hogging cut, is to remove as much material as possible, in as short a time as possible. When this is done it is important to guide the material being removed, safely, efficiently, and quickly, away from the face of the work piece, up the flutes of the end mill, and out of the workpiece area. Because of the pressures and heat generated between the end mill and the workpiece the feeds and speeds of end mills used on certain materials are sharply limited.

When removing material from a work piece it is known that breaking the material into discrete chips improves the ability of the removed material to flow more easily thereby reducing the pressure and heat on the tool. Prior art attempts to provide chip breakers on end mills have taken the form of providing axially or longitudinally located segments or notches on the cutting edges in order to break the material being removed from a workpiece into manageable chips. Specific examples may be viewed in U.S. Pat. No. 7,399,147 B1 to VanDyke, Jr. Such end mills, using either the notched cutting edges or the normal end mill, usually require a roughing pass that “hogs out” the main material and then requires a final pass to achieve the finish desired on the workpiece. Better finishes are achieved when the broken material being removed from the workpiece flows away from the face of the workpiece and up the flutes of the end mill.

### BRIEF SUMMARY OF THE INVENTION

A new chip breaking end mill is disclosed having an elongate cylindrically shaped body with opposing shank and cutter ends and at least one flute spirally formed around the center axis of the cylindrically shaped body, extending axially from the shank end to the cutting end. A longitudinally or axially extending cutting edge is formed by the intersection of the flute with the outer diameter of the cylindrically shaped body. A concave, facing outwardly, chip breaker groove is formed in the flute adjacent to the cutting edge and extends axially along with the cutting edge on the cylindrically shaped body. A chip guide channel is located adjacent to the chip breaker groove on the other side of the groove from the cutting edge and also extends axially along the length of the body. An axial extending raised intersection is formed between the adjacent chip breaker and chip guide. Two radial lines, one drawn from the centerline of said body through both the cutting edge and the other drawn from the centerline through a point on the raised intersection, have an acute included angle of from 2 to 20 degrees. The cutting end of the end mill has a radially extending cutting edge thereon. The flute may have a depth of up to 30 percent of the core diameter of the end mill. One side of the flute deemed the cutting edge side of the flute will comprise the cutting edge, the adjacent chip breaker groove and an adjacent chip guide section, all of which will extend from the cutting edge to the radial depth of the flute on the cylindrically shaped body. The width of the chip breaker groove between the cutting edge and the intersection, may range from 30 to 70 percent of the flute depth. Preferably the helix angle of the spiral flute and associated cutting edge will regress in a uniform manner from 40 degrees at the cutting end to 25 degrees at the shank end, but the helix angle of the flute may also just be constant in the range of from 15 to 40 degrees. It is contemplated that the end mill according to the present invention will have multiple flutes and when so configured the flute and cutting edges should be staggered in a non-uniform manner around a circle when viewed in an end view. For instance when there are four flutes and, from an end view, the flutes and radial cutting edges associated therewith are preferably located at substantially non-uniform circular positions such as 0, 84, 177, and 264 degrees.

### BRIEF DESCRIPTION OF THE DRAWINGS

FIG. 1 is a plan view of a prior art end mill.

FIG. 2 is a perspective view of a prior art end mill.

FIG. 3 is a plan view of the End Mill according to the present invention.

FIG. 4 is a cross-sectional view 4-4 through FIG. 3 of the End Mill according to the present invention.

FIG. 5 is a perspective view of the cutting end of the End Mill according to the present invention.

FIG. 6 is a cross-sectional view 6-6 through FIG. 5 of the End Mill according to the present invention.

FIG. 7 is a perspective cross-sectional view of the End Mill according to the present invention.

FIG. 8 is a cross-sectional view of an alternative embodiment of the End Mill according to the present invention.

FIG. 9 is a cross-sectional view of an alternative embodiment of the End Mill according to the present invention.

FIG. 10 is an enlarged cross-section taken at FIG. 10 circle of FIG. 6 of the End Mill according to the present invention.

### OBJECTS OF THE INVENTION

It is an object of the present invention to provide an end mill with a fluted chip control configurations.

It is an object of the present invention to provide an end mill with an efficient and novel chip control figuration.

It is an object of the present invention to provide an end mill capable of superior feeds and speeds.

It is an object of the present invention to provide an end mill that relieves radial cutting pressure on the tool.

It is an object of the present invention to provide an end mill that produces a tighter chip configuration for better productivity.

It is an object of the present invention to provide an end mill that allows improved productivity and superior surface finish.

It is an object of the present invention to provide an end mill that allows a single cutting operation for both rough and finish cutting.

It is an object of the present invention to provide and end mill that reduces excessive wear and produces a superior finish.

It is a further object of the present invention to provide an end mill that will reduce the number of milling operations for a finished part.

It is an object of the present invention to break the chips in a radial fashion rather than an axial fashion.

### DETAILED DESCRIPTION OF THE DRAWINGS

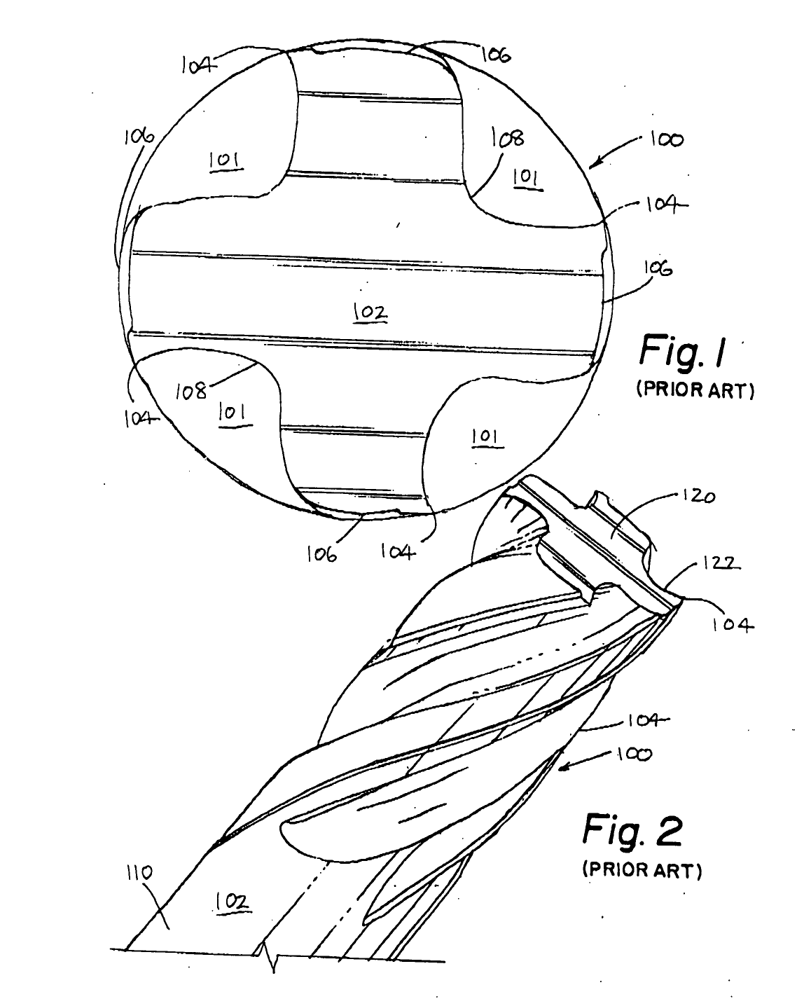

What is shown in FIGS. 1 and 2 is a prior art end mill at 100 having a cylindrically body 102 with a fluted areas 101 formed spirally in the cylindrically body 102. At the intersection of the flute areas 101 with the outer diameter of the cylindrically body 102 is formed a cutting edge at 104 and a radial relief area 106 that is behind each of the cutting edgings 104. In the fluted area 101 as it is bounded on one side by the cutting edge 104 and the other side by the relief area 106 is a chip flow guide area 108 that guides the chips being removed from the work piece up a long the cylindrical body 102 and out through the shank area 110. The cylindrical body 102 has a shank area 110 and end 120. On the end 120 are formed the cutting edges 122 which provide a positive rake to the cutting surface of the work piece.

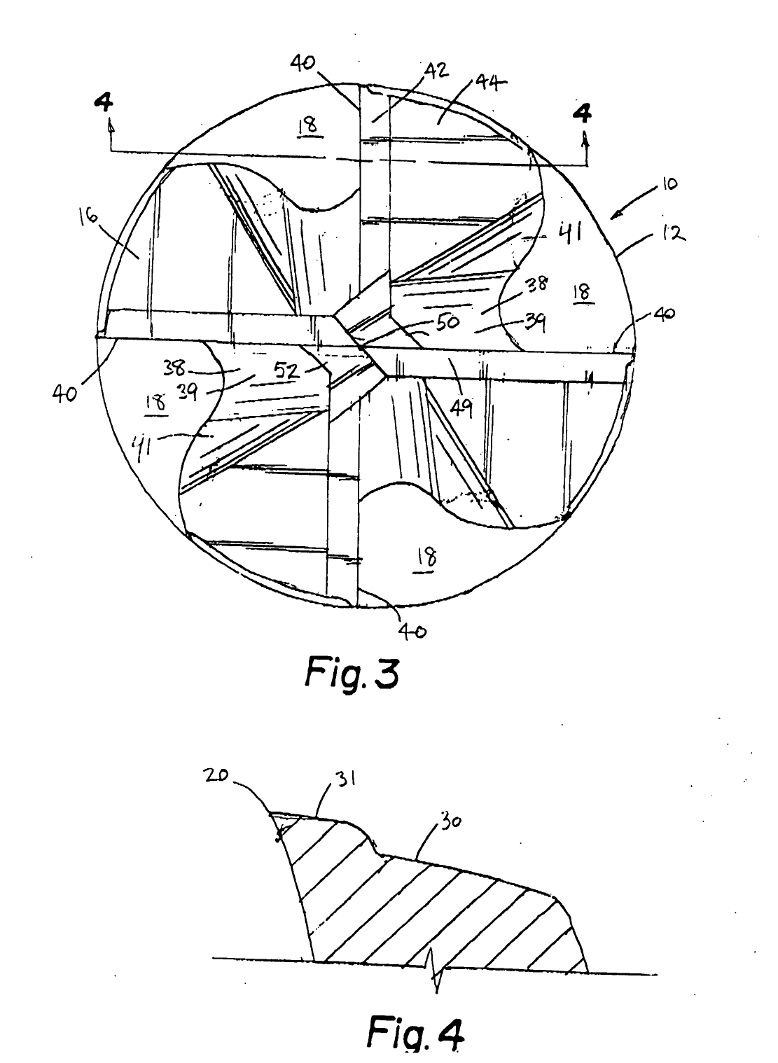

What is shown in FIG. 3 is an end view of the cutting end 16 of the cylindrical body 12 of the end mill 10 according to the present invention. Cutting end 16 is shown having radially extending cutting edges 40 that extend in a substantial perpendicular direction from the central axis 50 of the cylindrical body 12. Two center-cutting edge sections 49 and 52 are shown either touching or crossing the center line 50 of the central axis of the cylindrical body 12, and a gash area 38 is shown communicating with the flutes 18 of the cylindrical body 12. The gash area has three surfaces, surface 39 which is a sloping surface that communicates with the flute 18, surface 41 which communicates with the secondary relief surface of the radially extending cutting edges, and 43 which defines and forms the radial cutting edge at its intersection with the cutting end 16 of the cylindrically shaped body 12. The sloping area 39 is part of the gash and extends from near the center line 50 of the cylindrical body out to the flute 18 so that the chips cut by the center cutting edge portions 49 and 52 flow down the sloped clearance gash 39 and into the flute 18 and up the chip guide section. There is a primary relief angle shown at 42 behind the cutting edge 40 and the secondary relief area 44 shown in FIG. 3.

A preferable feature of the end mill according to the present invention is that the 4 cutting edges will be located in a non-uniform staggered circular positions from one another. For instance, the first cutting edge 40 at the top of FIG. 3 will be located at 0 degrees. The second cutting edge 40 located at the right on FIG. 3 will then be located off the 90 degree mark such as at 84 degrees. The next one will be the cutting edge 40 at the point end of the bottom of FIG. 3 which will be off of the 180 mark possibly at 177 degrees, and further the cutting edge 40 shown in the left side of FIG. 3 and pointing towards the left side of the page will be located off of the 270 degree mark preferably at 264 degrees. In this manner with the staggered cutting edges the end mill will prevent chattering or vibration while it is involved in its cutting operation. As can be seen, the grinding wheel that provides the gash area provides a neutral rake angle on the radially extending cutting edges and the sloping gash areas 39 and 41 provide areas for the chips to flow from the center out to the flute area 18 and once in the flute area 18 will flow up the chip guide section 24 and out of the work piece area.

Other areas shown in FIG. 4 are a primary relief area 31 shown behind the radially extending cutting edges 20 along with the secondary relief area 30.

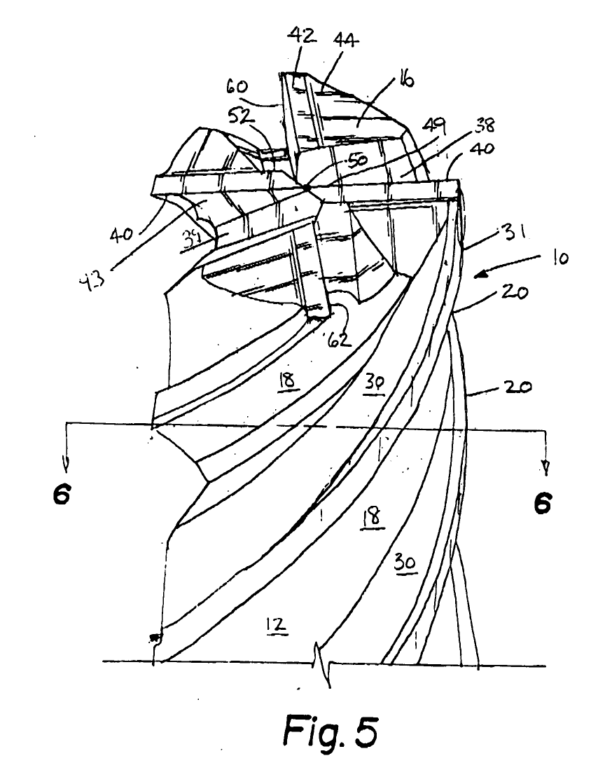

What is shown in FIG. 5 is the end mill 10 according to the present invention. Showing a perspective view of the cutting end configuration 16 of the cylindrical body 12. As can be seen in FIG. 5 the cutting end 16 in this particular embodiment has 4 flutes 18 shown on the cylindrically shaped body 12 with the associated cutting edges 20 showing that the intersection of the outer diameter of the cylindrical body 12 with the flutes 18. The primary relief area relief angle 31 is shown along with the secondary relief area 30 on the cutting end 16. On cutting end 16 are also radially extending cutting edges 40 that extend substantially perpendicular to the central axis 50 of the cylindrical body 12 and on 2 cutting edges shown at 49 and 52, there are center portion which may overlap by a small amount to center line 50 of the cylindrical body 12. The other set of cutting edges shown at 60 and 62 do not and cannot extend to the center line of the cylindrical body 12 and cooperate with the center-cutting cutting edges 49 and 52 shown in FIG. 5. A gash area 38 is shown in front of each particular cutting edge. The gash area is an area formed by a grinding wheel coming down into the end of the cutting face and forming 3 distinct surfaces. An adjacent gash area 39 forms the cutting edge shown at 40 while a sloping section 41 of the gash area slopes from approximately the center line of the cylindrical body 12 out to communicate with its associated flute that has extended axially from the shank area into the cutting end area.

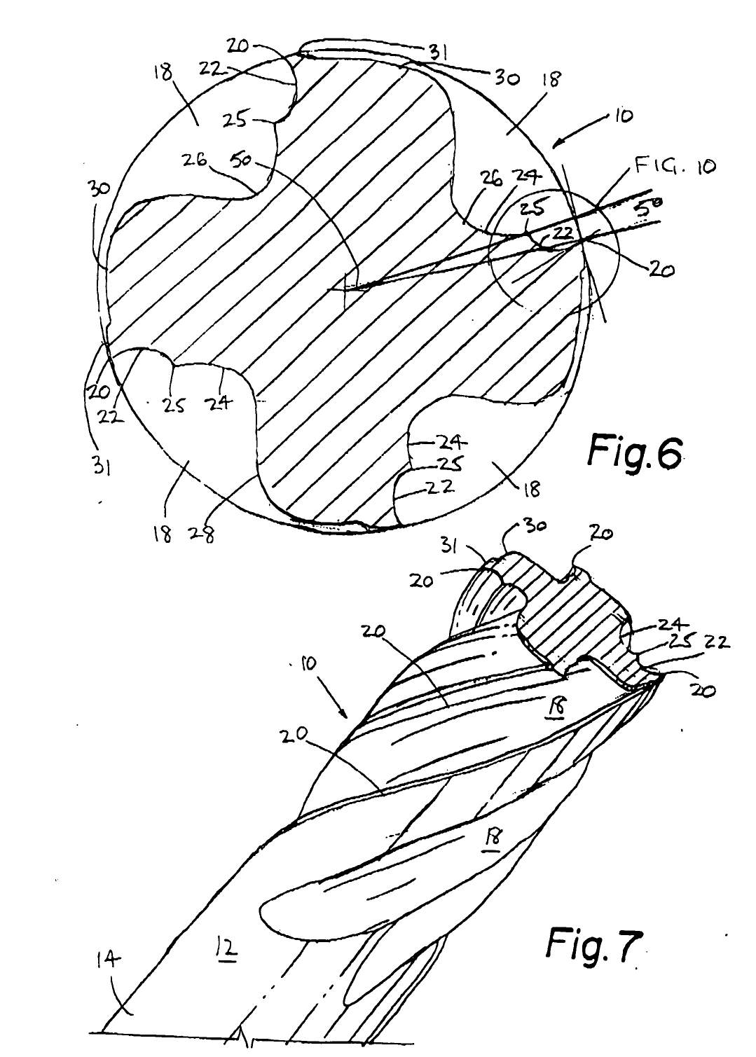

Showing in FIG. 6 is a further showing of the cutting edge 20. The primary relief angle 31 which is usually in the area from 5 to 6 degrees and the secondary relief area 30 behind the primary relief angle 31. The flutes are shown that they are formed of the chip breaker groove 22 which is adjacent to the cutting edge 20 with a raised intermediate section at 25 of being defining the adjacent relationship between the chip breaker groove 22 and the chip guide section 24. The intermediate section 25 can be a point or a line that extends axially along the center line of the cylindrical body 12.

As can be seen more clearly in FIG. 6 there are two radius lines drawn from the center line 50 of the cylindrically shaped body 12 with a first radial line extending out through the raised intersection 25 between the chip groove 22 and the chip guide area 24. A second radial line is drawn from the center line 50 out through the cutting edge point 20 that was formed by the intersection of the flute 18 with the outer diameter of the cylindrical body 12.

As is shown in FIG. 6 there is a 5 degrees acute included angle between these two radial lines and insures that as the chip is removed from the material by cutting edge 20 it will come down into the chip groove 22 and be curled and broken by the chip groove 22 and will contact the cylindrical shaped body 12 somewhere prior to the point 25 as is preferable in the invention. This angle may vary between 2 and 20 degrees depending on the type of material that is desired to be milled. What is also shown in FIG. 6 is that the depth of the chip groove 22 as it extends from the outer diameter of the cylindrically shaped body 12 to the depth of the flute as is shown in 26 is equal to the dimension of the chip guide section 24 as it extends from the bottom of the flute 26 up to the intersection with the chip guide 22. In FIG. 6 the dimensions are equal, and the chip guide section is preferably in the dimension of 30 percent of the core diameter 26 of the cylindrically shaped end mill 10. As an example for a three-quarter inch outside diameter 4 fluted end mill the core diameter would preferably be 0.420 inches and the flute depth would be 0.165 inches.

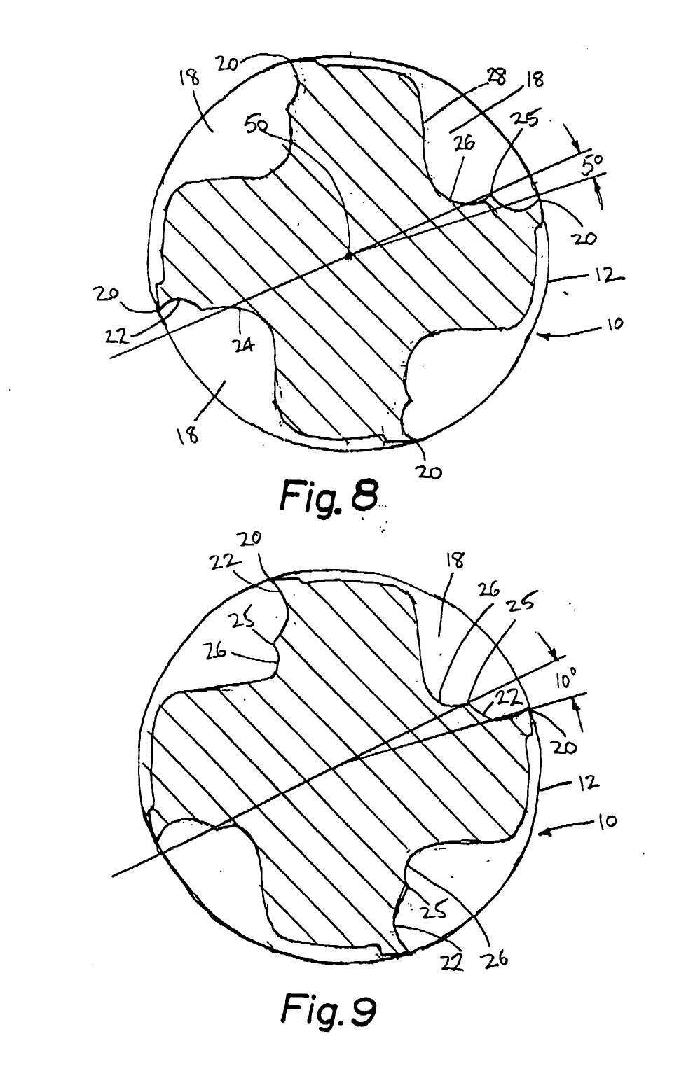

What is shown in FIG. 7 is an end mill 10 according to the present invention. The end mill 10 comprises a cylindrically shaped body 12 with the cylindrically shaped body 12 having a shank end 14 and a cutting end 16. The cutting end 16 is more clearly shown over in FIGS. 3 and 5, as what is shown in FIG. 7 is merely a cross section of the end mill or cylindrical body 12 without the cutting end configuration shown therein. Flutes 18 are formed in the cylindrically shaped body 12 and extend from the shank end 14 toward the cutting end 16. Axially extending cutting edges 20 are formed at the intersection of the flutes 18 with the outer diameter of the cylindrically body 12. These cutting edges are axially extending along the center axis of the cylindrical body 12 and extend from the shank area 14 to the cutting end 16. A chip breaker groove 22 is formed along the flute 18 and adjacent to the axially extending cutting edges 20. The chip breaker 22 is concave facing outwardly of the cylindrical body 12 and extends axially along the center line of the cylindrical body 12 just as the flutes in the cutting edges do. Adjacent to the chip breaker groove 22 in the flute 18 is a chip guide section 24 that extends from one side of the chip breaker groove 22 to the bottom 26 of the flute or otherwise known as the core diameter of the end mill. The groove 22 and chip guide section form one side of the flute 18, and there is an opposing side 28 that extends from the bottom 26 of the flute upwards toward the secondary relief area 30.

The secondary relief 30 of the axially cutting edge 20 is shown in FIG. 7. The axially extending cutting edge 20 also has a primary relief angle extending along the cutting edge so that when cutting the piece as the cutting edge passes the work piece there is nothing behind it to rub the finish of the work piece material.

What is shown in FIG. 8 is an alternate embodiment of the end mill 10 according to the present invention. Shown therein is the cross section of the cylindrical body 12 along its axially length having a center point 50 and having cutting edges 20 axially extending along the center line 50 of the cylindrical body 12. The groove 22 and chip guide section form one side of the flute 18, and there is an opposing side 28 that extends from the bottom 26 of the flute upwards toward the secondary relief area 30. In this case, the radial lines drawn from the center line 50 through the intermediate point 25 and the radial line drawn from the center point 50 through the cutting edge 20 form an acute included angle of 5 degrees and the distance of the chip groove 22 from the cutting edge 20 to the intermediate point 25 is approximately half the distance of the depth of the chip guide section 24 from the intermediate point 25 to the bottom at 26 of the flute 18. The actual chip groove may vary in dimension to be 30 to 70 percent of the flute depth.

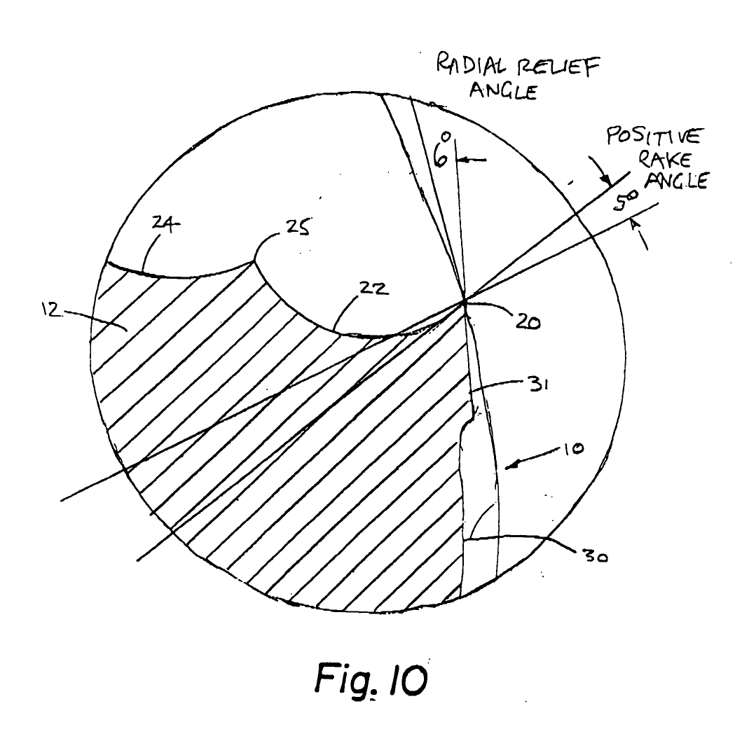

Shown in FIG. 9 is still another alternate embodiment of the present invention showing the end mill 10 according to the present invention having the cylindrical body 12 with the flutes 18 similarly positioned as in FIG. 8. In FIG. 9, the acute included angle between the radius going through the center point 50 through the intermediate section point 25 and the radial line going from the center point 50 through the cutting edge point 20 shows an acute included angle of 10 degrees, and in this case the width of the chip groove 22 from the cutting edge 20 to the intermediate point 25 is at least twice the width of the depth of the chip guide section from the intermediate point 25 to the flute depth 26.

Shown in FIG. 10 is a blown up area of the circled area in FIG. 6 referring you to FIG. 10. The details of the cutting edge 20 of the end mill 10 according to the present invention are shown. The chip groove 22 is shown adjacent to the chip guide section 24 and is thereby separated by the radius intermediate land or point 25, the cutting edge 20 as a primary relief angle shown at 31 and a secondary relief area shown at 30. The cutting edge as shown is shown presenting a positive rake angle of 5 degrees to the work piece as a cylindrically shaped body 12 rotates past the work piece. The radial relief angle 31 is shown as being approximately 6 degrees.

The invention has been described in terms of its best mode. The invention is not limited to the disclosed embodiment. The invention covers various modifications and equivalent arrangements included within the spirit and scope of the following claims.

I claim:

1. An end mill comprising:
a. an elongate cylindrically shaped body having opposing shank and cutter ends;
b. at least one flute spirally formed around a center axis of said cylindrically shaped body and extending axially from said shank end to said cutting end;
c. an axially extending cutting edge formed by the intersection of said flute with the outer diameter of said cylindrically shaped body;
d. a concave facing outwardly chip breaker groove formed in said flute adjacent said cutting edge and extending axially of said cylindrically shaped body;
e. a chip guide channel adjacent to said chip breaker groove and extending axially of said body;
f. a raised intersection between said chip breaker and said chip guide which extends axially of said cylindrically shaped body;
g. radial lines drawn from the centerline of said body through both the cutting edge and said raised intersection having an included angle of from 2 to 20 degrees;
h. a radially extending cutting edge on said cutting end of said cylindrical body.

2. The end mill according to claim 1 in which said flute has a core depth of up to 30 percent of the diameter of said cylindrically shaped body.

3. The end mill according to claim 2 in which the cutting edge side of said flute comprises the cutting edge, the adjacent chip breaker groove and an adjacent chip guide section which extends to the radial depth of the flute on the cylindrically shaped body.

4. The end mill according to claim 3 in which the width of the chip breaker groove between the cutting edge and the intersection, ranges from 30 to 70 percent of the flute depth.

5. The end mill according to claim 4 in which the helix angle of the spiral flute and associated cutting edge regress from 40 degrees at the cutting end to 25 degrees at the shank end.

6. The end mill according to claim 4 in which the helix angle of said flutes is in the range of from 15 to 40 degrees.

7. The end mill according to claim 6 in which there are multiple flutes formed on said cylindrically shaped body.

8. The end mill according to claim 1 in which there are at least four flutes and, from an end view, the flutes and radial cutting edges associated therewith are located at substantially non-uniform circular positions substantially close to the positions of 0, 84, 177, and 264 degrees.
